(19) United States
(12) Patent Application Publication
(10) Pub. No.: US 2018/0266457 A1
(43) Pub. Date: Sep. 20, 2018

(54) Moveable Electronic Device Fixation Clamp

(71) Applicant: Pengcheng DU, Guangdong (CN)

(72) Inventor: Pengcheng DU, Guangdong (CN)

(21) Appl. No.: 15/867,709

(22) Filed: Jan. 11, 2018

(30) Foreign Application Priority Data
Mar. 15, 2017 (CN) 201720249721.5

(51) Int. Cl. F16B 2/18; F16B 2/12

(52) U.S. Cl. CPC F16B 2/185; F16B 2/12

(57) ABSTRACT

A new mobile electronic device fixation clamp has a shell body, a control mechanism, a first clamp arm, a second clamp arm and a resetting mechanism; the control mechanism has a control block and a pulling plate; the control block is arranged on the shell body moveably and rotatably; the pulling plate is connected with the control block; the first clamp arm and the second clamp arm are arranged on the shell body slidably and are connected with two sides of the control block, respectively; the resetting mechanism triggers the pulling plate to reset. During use, the control block is pulled to rotate, thereby driving the first clamp arm and the second clamp arm to slide, and accordingly changing a distance between the first clamp arm and the second clamp arm and thus holding and fixing the mobile electronic device therebetween.

### BACKGROUND OF THE INVENTION

The utility model is related to the field of electronic device, especially a moveable electronic device fixation clamp.

Under a working and living mode of new era, outdoor activities of human beings are increasing day by day, and new outdoor products are increasing accordingly. People are broadening their footprints and extend their demands for bringing social contact and living habits to the activities. Further, people hope to record and share splendid moments shot during the activities and images of moments in daily activities with portable digital devices, such as a mobile phone and a camera.

However, the majority of fixation clamps of current mobile electronic device (such as the mobile phone and the camera) supports are uniaxial tensile structures, and cannot hold the mobile electronic device firmly and be operated with single hand.

### BRIEF SUMMARY OF THE INVENTION

An embodiment of the utility model is to provide a new mobile electronic device fixation clamp, to hold the mobile electronic device firmly and operate with single hand.

In order to solve the above-mentioned technical problems, the embodiment of the utility model provides the new mobile electronic device fixation clamp comprising a shell body, a control mechanism, a first clamp arm, a second clamp arm and a resetting mechanism, wherein

The control mechanism comprises a control block and a pulling plate; the control block is arranged on the shell body moveably and rotatably; the pulling plate is connected with the control block; the first clamp arm and the second clamp arm are arranged on the shell body slidably and are connected with two sides of the control block, respectively; the resetting mechanism triggers the pulling plate to reset; during using, the control block is pulled to rotate through the pulling plate, thereby driving the first clamp arm and the second clamp arm to slide, and accordingly changing a distance between the first clamp arm and the second clamp arm and holding and fixing the mobile electronic device through an interaction between the first clamp arm and the second clamp arm.

Further, the control mechanism also comprises a guide rod and a spring sleeved on the guide rod; one end of the guide rod is arranged on the shell body, and the other end is placed against one end of the spring; and the pulling plate is sleeved on the guide rod moveably and placed against the other end of the spring.

Further, the resetting mechanism comprises a resetting fastener, a resetting elastic part and a resetting plate; the resetting fastener is a reversed T-shaped fastener, its bottom is wound on the shell body moveably, and its top is used to fasten the pulling plate which is pulled to a predetermined position; two ends of the resetting elastic part are placed against the shell body and a top of the resetting fastener, thereby providing the resetting fastener with elastic force for resetting; and the resetting plate is connected with the resetting fastener and protrudes out of the shell body, for contacting with the moveable electronic device clamped to trigger rotation of the resetting fastener and separation from the pulling plate.

The embodiment of the utility model provides the new mobile electronic device fixation clamp comprising the shell body, the control mechanism, the first clamp arm, the second clamp arm and the resetting mechanism; the control block is controlled to rotate through the pulling plate, thereby driving the first clamp arm and the second clamp arm to clamp and fix the moveable electronic device; therefore the user can push the pulling plate with single hand. The mobile electronic device fixation clamp solves the problem of uniaxial tensile structure; and accordingly, the mobile electronic device can be held firmly and the user is facilitated to operate with single hand.

### BRIEF DESCRIPTION OF THE DRAWINGS

FIG. 1 is a schematic diagram of a front-side structure of a new mobile electronic device fixation clamp in an embodiment of the utility model.

FIG. 2 is the schematic diagram of a back-side structure of the new mobile electronic device fixation clamp in the embodiment of the utility model.

FIG. 3 is the schematic diagram of an internal structure of the new mobile electronic device fixation clamp in the embodiment of the utility model.

FIG. 4 is an explosive view of the new mobile electronic device fixation clamp in the embodiment of the utility model.

### DESCRIPTION OF NUMBERS IN THE DRAWING

Shell body 10

Control mechanism 20

Control block 21

Pulling plate 22

Guide rod 23

Spring 24

The first clamp arm 30

The second clamp arm 40

Resetting mechanism 50

Resetting fastener 51

Resetting elastic part 52

Resetting plate 53

### DETAILED DESCRIPTION OF THE INVENTION

It's important to note that an embodiment in the application and characteristics in the embodiment can be combined with each other on the premise that no conflict occurs; the following shall further describe the utility model detailedly in connection with a drawing and the specific embodiment.

A direction indication (such as up, down, left, right, front, back, . . . ) (if any) in the embodiment of the utility model is used to illustrate a relative position relationship between all parts under certain specific posture, moving condition, etc. only; and if this specific posture is changed, the direction indication shall be changed accordingly.

Further, phrases, such as “The first” and “The second” involved in the utility model, are used to describe the objective only rather than understood as a quantity indicating or implying its relative importance or implicitly implying technical characteristics indicated. Therefore, the characteristics limited with “The first” and “The second” indicate or implicitly include at least one of these characteristics.

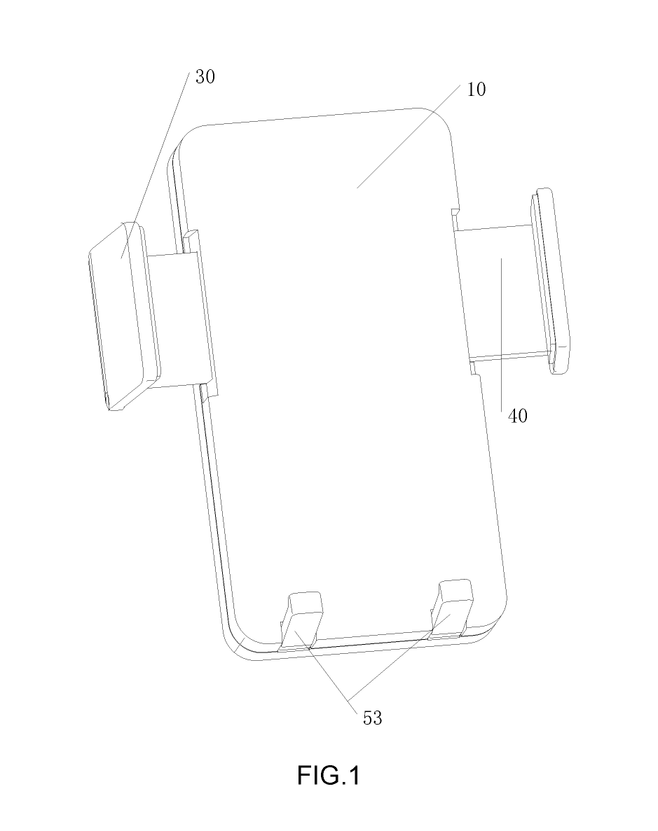

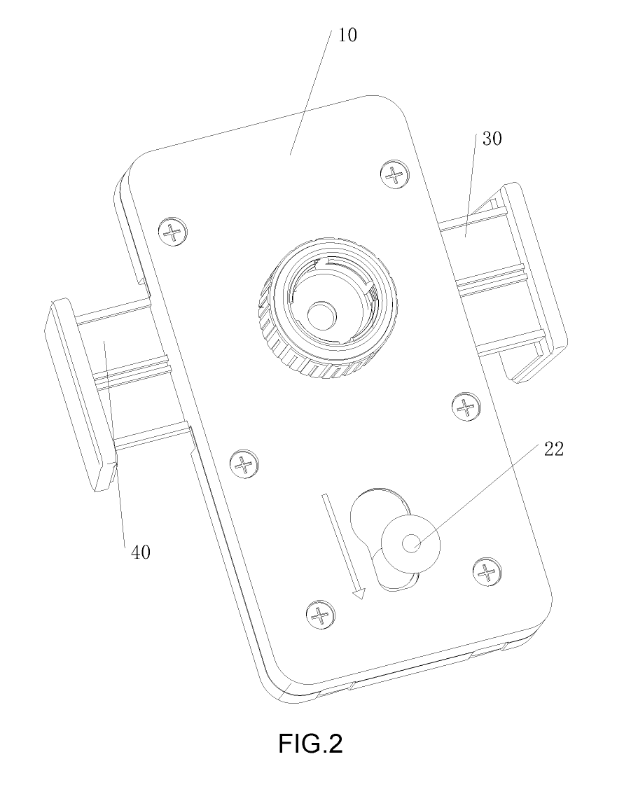

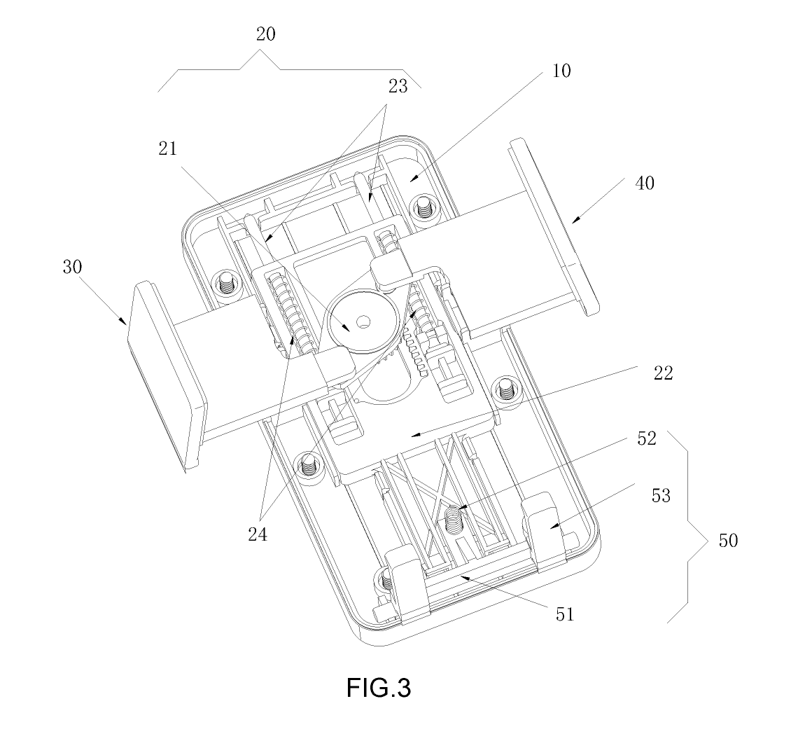

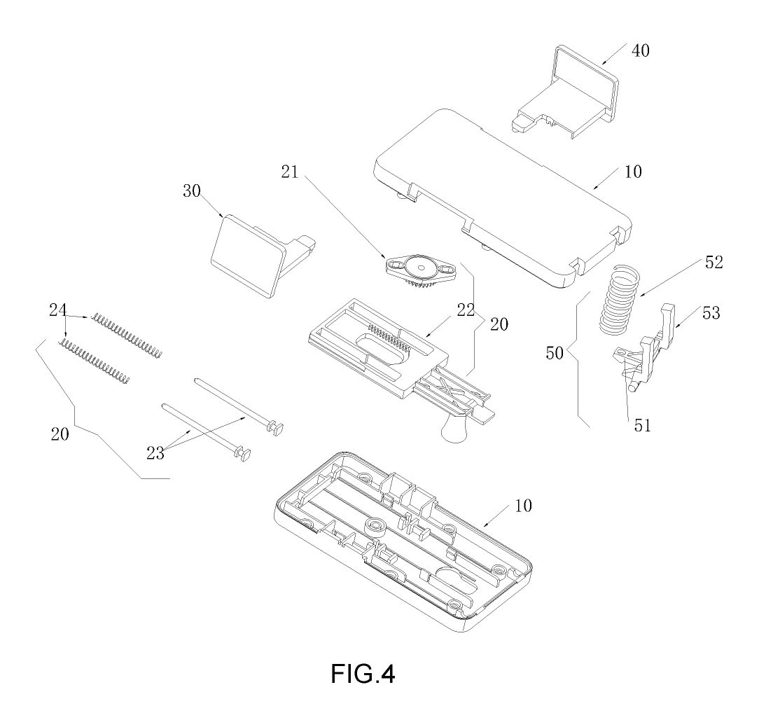

By referring to FIG. 1-4, a new mobile electronic device fixation clamp in the embodiment of the utility model mainly comprises a shell body 10, a control mechanism 20, a first clamp arm 30, a second clamp arm 40 and a resetting mechanism 50.

The control mechanism 20 comprises a control block 21 and a pulling plate 22; the control block 21 is arranged on the shell body 10 moveably and rotatably; the pulling plate 22 is connected with the control block 21. The first clamp arm 30 and the second clamp arm 40 are arranged on the shell body 10 slidably and are connected with two sides of the control block 21, respectively. The resetting mechanism 50 triggers the pulling plate 22 to reset. During using, the user can pull the control block 21 to rotate by pulling the pulling plate 22 only through single hand, therefore the first clamp arm 30 and the second clamp arm 40 are driven to slide; and accordingly, a distance between the first clamp arm 30 and the second clamp arm 40 is changed, and the mobile electronic device can be held and fixed through an interaction between the first clamp arm 30 and the second clamp arm 40.

As a mode of execution, the control mechanism 20 also comprises a guide rod 23 and a spring 24 sleeved on the guide rod 23; one end of the guide rod 23 is arranged on the shell body 10, and the other end is placed against one end of the spring 24; and the pulling plate 22 is sleeved on the guide rod 23 moveably and one end thereof is placed against the other end of the spring 24. The other end of the pulling plate 22 protrudes out of the shell body 10, thereby facilitating pushing and pulling of the user. The spring 24 acts on the pulling plate 22, thereby providing the first clamp arm 30 and the second clamp arm 40 with an elastic force to clamp the mobile electronic device.

As the mode of execution, the resetting mechanism 50 comprises a resetting fastener 51, a resetting elastic part 52 and a resetting plate 53. The resetting fastener 51 is a reversed T-shaped fastener, its bottom is wound on the shell body 10 moveably, and its top is used to fasten the pulling plate 22 which is pulled to a predetermined position; two ends of the resetting elastic part 52 are placed against the shell body 10 and a top of the resetting fastener 51, thereby providing the resetting fastener 51 with elastic force for resetting. The resetting plate 53 is connected with the resetting fastener 51 and protrudes out of the shell body 10, for contacting with the moveable electronic device clamped to trigger rotation of the resetting fastener 51 and separation from the pulling plate 22. During use, the pulling plate 22 is pulled backward to drive the first clamp arm 30 and the second clamp arm 40 to unfold; at the same time, the resetting fastener 51 is triggered automatically to hook the pulling plate 22, thereby maintaining the mobile phone clamp arm unfolded; the mobile electronic device is placed on the shell body 10 to contact with the resetting plate 53, and the resetting fastener 51 is separated from the pulling plate 22; in this way, the first clamp arm 30 and the second clamp arm 40 are closed to clamp the mobile phone in presence of the spring 24.

Although the embodiment of the utility model is shown and described, as for common technicians of this field, any variations, revisions, substitutions and modifications of these embodiments without breaking away from the theory and spirit of this utility model shall be allowed; and a range of the utility model is defined by claims and equivalent range thereof.

What is claimed is:

1. A new mobile electronic device fixation clamp, comprising a shell body, a control mechanism, a first clamp arm, a second clamp arm and a resetting mechanism, wherein the control mechanism comprises a control block and a pulling plate; the control block is arranged on the shell body moveably and rotatably; the pulling plate is connected with the control block; the first clamp arm and the second clamp arm are arranged on the shell body slidably and are connected with two sides of the control block, respectively; the resetting mechanism triggers the pulling plate to reset; during using, the control block is pulled to rotate through the pulling plate, thereby driving the first clamp arm and the second clamp arm to slide, and accordingly changing a distance between the first clamp arm and the second clamp arm and holding and fixing the mobile electronic device through an interaction between the first clamp arm and the second clamp arm.

2. The new mobile electronic device fixation clamp according to claim 1, wherein the control mechanism further comprises a guide rod and a spring sleeved on the guide rod; one end of the guide rod is arranged on the shell body, and the other end is placed against one end of the spring; and the pulling plate is sleeved on the guide rod moveably and placed against the other end of the spring.

3. The new mobile electronic device fixation clamp according to claim 1, wherein the resetting mechanism comprises a resetting fastener, a resetting elastic part and a resetting plate; the resetting fastener is a reversed T-shaped fastener, its bottom is wound on the shell body moveably, and its top is used to fasten the pulling plate which is pulled to a predetermined position; two ends of the resetting elastic part are placed against the shell body and a top of the resetting fastener, thereby providing the resetting fastener with elastic force for resetting; and the resetting plate is connected with the resetting fastener and protrudes out of the shell body, for contacting with the moveable electronic device clamped to trigger rotation of the resetting fastener and separation from the pulling plate.
